(19) United States
(12) Patent Application Publication
(10) Pub. No.: US 2007/0151660 A1
(43) Pub. Date: Jul. 5, 2007

(54) Process for manufacturing RFID label

(76) Inventors: Matt Adams, Mason, OH (US); Otto Argadine, Centerville, OH (US); Doug Taylor, Everett, WA (US); Kevin Conwell, Fairfield, OH (US); Rick O'Brien, Kirkland, WA (US); Jim Peternel, Everett, WA (US)

Correspondence Address: Orum & Roth LLC;Ste 1616, 53 W Jackson Blvd, Chicago, IL, 60604, US

(21) Appl. No.: 11/318,366

(22) Filed: Dec. 23, 2005

(51) Int. Cl. B65C 9/18; G08B 13/14

(52) U.S. Cl. 156/238; 340/572.8

(57) ABSTRACT

An automated process for manufacturing smart labels having a radio frequency identification transponder (RFID) transponder. The inventive method accurately and reliably inserts RFID transponders into labels on onto tags 70 in one pass on a label press 100 equipped with an in-line insertion station 120. The transponders may be provided in continuous supply reel and singulated as needed to form discrete terms transponders or single transponders may be provided in the hopper. The label is delaminated and the transponders are individually applied directly to the adhesive side of the labels in the machine direction of the moving web. The label liner is then relaminated back onto the label face stock sandwiching the RFID transponder between the liner and the label stock.

### BACKGROUND OF THE INVENTION

1. Field of the Invention

The present invention relates to an automated process for manufacturing smart labels having radio frequency transponders (RFID) capable of interrogation by reader.

2. Description of the Related Art

Bar codes have historically been used for tracking and identifying articles. While bar-code labels are relatively inexpensive, they have limitations. Barcode labels require a direct line of sight with a barcode scanner in order to be effective. Barcode labels can only be read one at a time. Once the barcode is printed, the data stored within the bar code cannot be updated or modified. The amount of information that can be contained in the bar code is limited.

Commonly used barcodes include 1D barcodes and 2D or matrix barcodes. 1D bar code symbologies have two or more different widths of straight-line black bars. The spaces and bars of a 1D bar code are a simplified language that can be understood by a computer. Stacked symbology or multi-row bar codes are bar codes made up of a series of 1D bar codes. The data is coded in a series of bars and spaces of varying width. These bar codes contain more information that 1D bar codes. Matrix code or 2D bar codes are bar codes in which the information is stored along the height and width of the symbol. Within the symbol, each black element is the same dimension and it is the position of the element that codes the data. The information is based on the position of black spots within a matrix.

If a bar code image is ripped, torn, wrinkled, smeared has voids or other printing defects or is otherwise damaged, the information may be unreadable. Moreover, because barcodes are visual they are inherently unsecure.

An RFID transponder is a radio frequency identification transponder comprising an application-specific integrated circuit (ASIC), which is commonly referred to as a chip or die. The ASIC is attached to an antenna. RFID transponders may either be passive, i.e. powered by the readers' electromagnetic field or active, i.e. powered by an onboard battery.

Smart labels or tags are labels or tags, with radio frequency identification transponders 70 (also known as RFID tags, RFID chips, inserts, inlays, or inlets) offer several advantages over barcode labels. These advantages include higher data capacity, the ability to read/write information, the ability to read/write to labels or tags 70 not in the line of sight of the reader, and the ability to read multiple labels or tags 70 at one time.

Most smart labels or tags use flexible RFID transponders having a plastic base film substrate to support the antenna circuit. Even flexible RFID transponders are relatively fragile. Bending can cause cracking or damage to their circuits. Thus, prior art RFID smart labels and tags are hand assembled and hand inspected. Hand assembling and hand inspecting smart labels is an extremely time consuming and expensive process. An automated manufacturing process needed.

There is a need for insertion equipment that is capable of introducing the RFID transponder in a manner that protects the chip and antenna.

### SUMMARY OF THE INVENTION

The present invention is an automated process for manufacturing smart labels and tags having an RFID transponder. The inventive method provides an efficient, accurate and reliable process for manufacturing labels or tags with RFID transponders using one pass on a label converting press equipped with an in-line insertion station.

Because RFID transponders are relatively fragile and bending can cause cracking or damage to their circuits, the insertion equipment must be capable of introducing the RFID transponder in a manner that protects the chip and antenna.

Label or tag stock is run through a label converting press where the label or tag is typically printed and die cut. RFID transponders are provided as a web on a continuous supply reel 131 and singulated as needed to form discrete transponders or single transponders may be provided in a hopper bin. As RFID transponders are singulated, each individual transponder is applied directly to the labels or tags in the machine direction of the moving web.

A continuous supply role of label stock laminate is provided for this process. Label stock is preferably comprised of a face sheet having an adhesive on one side laminated to release liner. The system comprises a separating mechanism to separate the label face with the adhesive from the release liner. This is known as delamination. The label face sheet is transported to an insertion station where an RFID transponder is inserted onto the adhesive side of the face sheet. After insertion of the RFID transponder, a relamination mechanism brings the label face stock with the adhesive and RFID transponder back into contact with the release liner. Preferably, a pair of rollers is provided on press for this purpose.

The label face stock with the RFID transponder is transported through a die cutting station, which may be used to perforate the web, form single labels, or both. The die cutting station is held in registration with the insertion station so that the label stock may be cut without cutting through an RFID transponder.

The process also provides one or more printing stations prior to the insertion station for printing on the label stock and optionally an adhesive applicator for applying adhesive to the RFID transponder while keeping the components in registration.

A similar insertion process is used for non-adhesive tags 70 without the delamination and relamination steps.

In addition, the insertion process optionally provides one or more programming and/or verifying stations for programming and/or verifying the functionality of each RFID transponder either online during the insertion process and/or off-line.

### BRIEF DESCRIPTION OF THE FIGURES

FIG. 1 is a cross-section of an RFID smart label;

FIG. 2 is a cross section of an alternative embodiment of an RFID smart label;

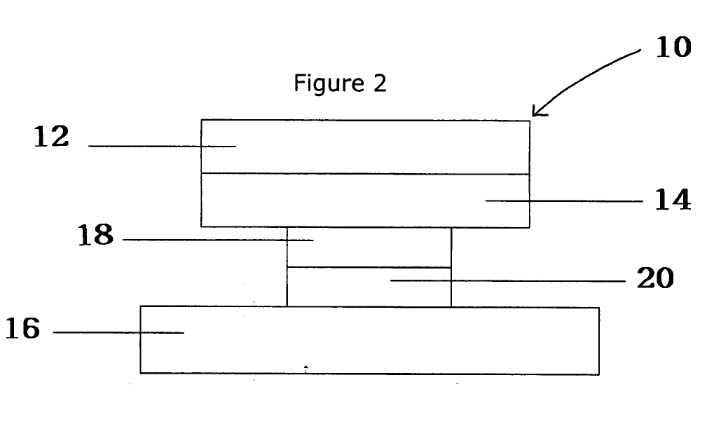

FIG. 3 is a cross-section of an RFID smart tag;

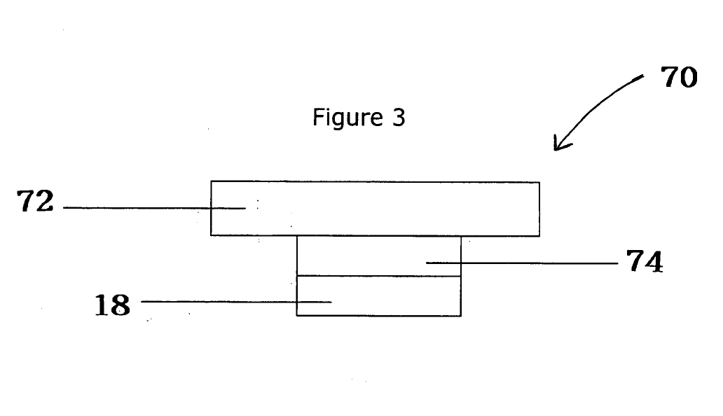

FIG. 4 is a cross section of an alternative embodiment of an RFID smart tag;

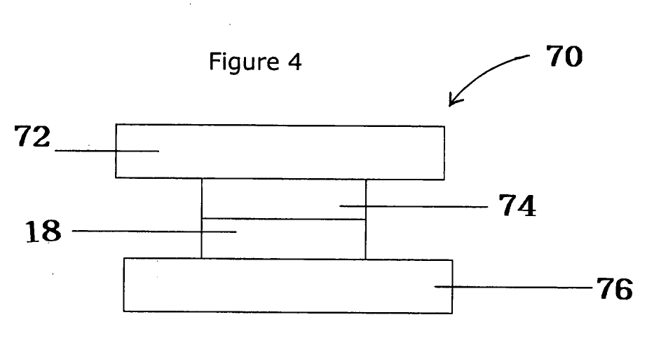

FIG. 5 is a block diagram of the RFID smart label manufacturing process;

FIG. 6 is a block diagram of the RFID smart tag manufacturing process;

FIG. 7 is a block diagram of optional off-line processing;

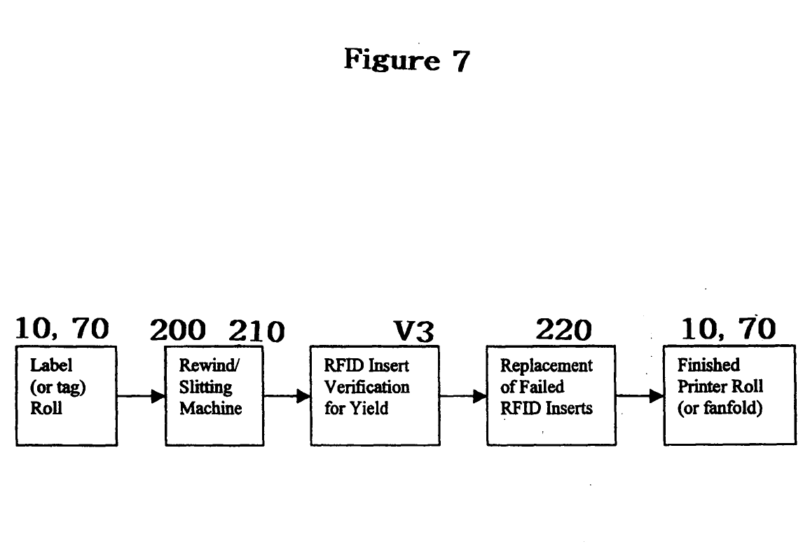

FIG. 8 is a diagram of overhead tower for label face/insert handling; and

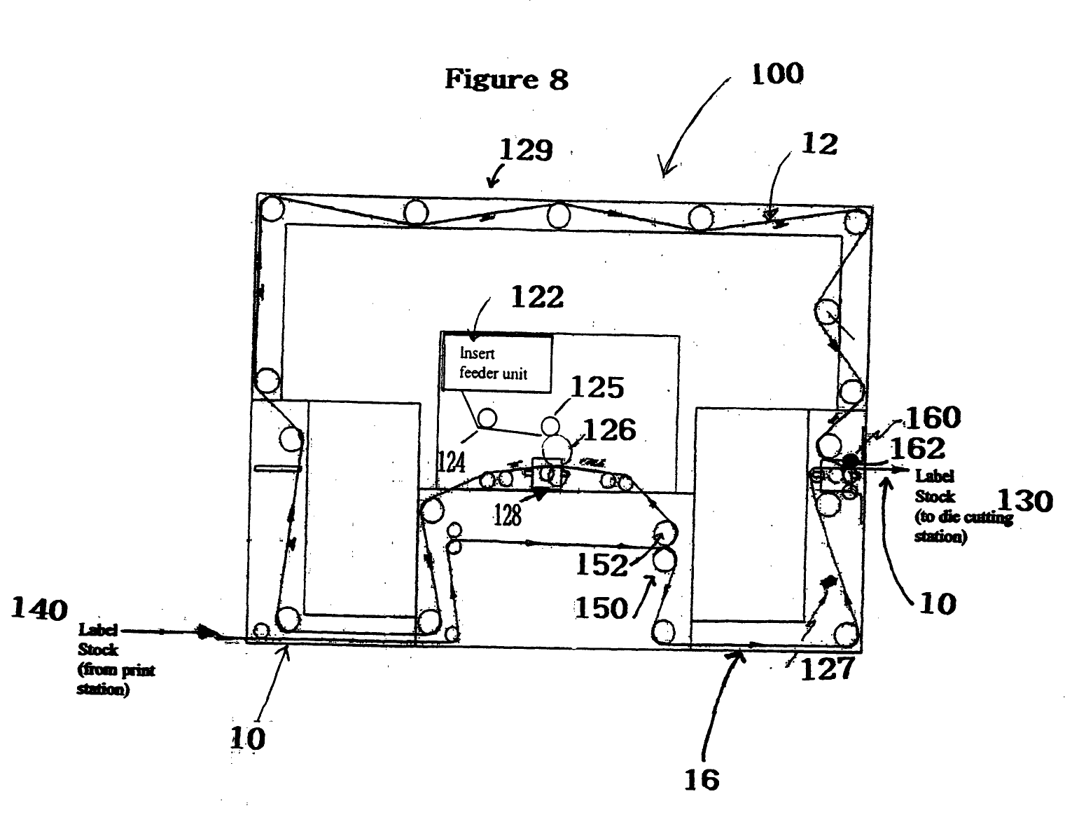

FIG. 9 is a diagram of insertion station.

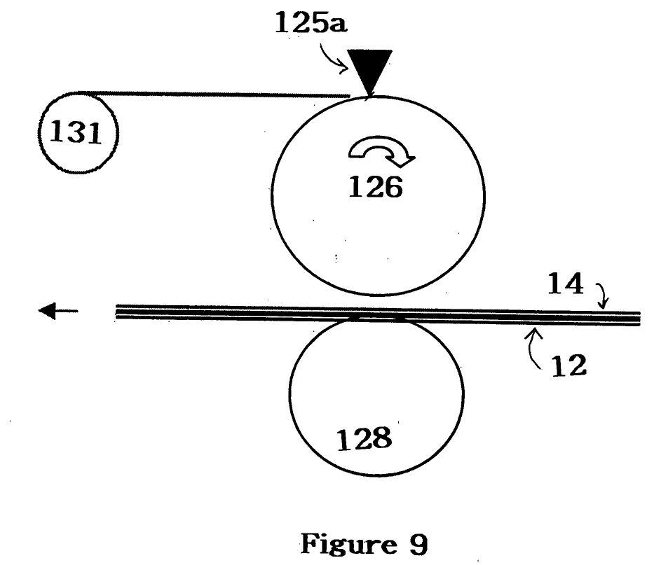

### DETAILED DESCRIPTION OF THE INVENTION

The present invention is an automated process for manufacturing smart labels or tags having an RFID transponder. The inventive method provides an efficient, accurate and reliable process for successfully manufacturing RFID labels or tags using one pass on a label converting press 100 equipped with an in-line insertion station 120.

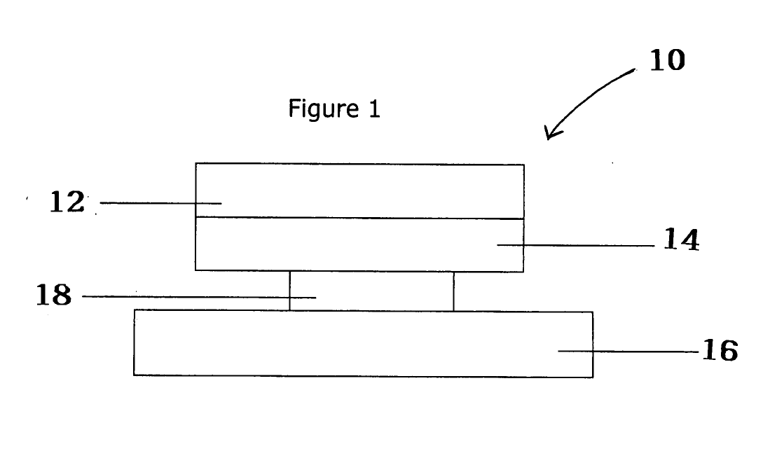

A smart label 10 is shown in FIG. 1. Smart label 10 is a layered construction comprising a label face sheet 12, a release liner 16, an adhesive layer 14 between the label face sheet 12 and the liner 16 and an RFID transponder 18 between the label face sheet 12 with adhesive 14 and the liner 16. Optionally, there may be an adhesive layer 20 or adhesive patch on the back of the RFID transponder, multiple inserts 18, multiple label face sheets 12 and/or multiple liner 16 layers. Multiple label face sheets 12 and multiple liner sheets 16 are useful in piggyback or multi-layer forms.

An RFID transponder 18 (also referred to as an RFID tag, insert, inlay, or inset) is a radio frequency identification transponder comprising an application-specific integrated circuit (ASIC), which is also referred to as a chip or die. The ASIC is attached to an antenna. The RFID transponders 18 is preferably a flexible RFID transponder having a plastic base film substrate to support the antenna and ASIC. RFID transponders 18 may either be passive, i.e. powered by the readers' electromagnetic field or active, i.e. powered by an onboard battery.

RFID transponders 18 are provided as a web on a continuous supply reel and singulated as needed to form discrete RFID transponders. Alternatively, single RFID transponders 18 are provided in a hopper bin. As the RFID transponders 18 are singulated, each individual RFID transponder 18 is applied directly to the adhesive 14 side of labels 10 in the machine direction of the moving web.

A continuous supply roll of label stock laminate 10 is provided for this process. Label stock laminate 10 comprises a face sheet 12 having an adhesive 14 on one side laminated to release liner 16. The system comprises a separating mechanism 150 to separate the label face sheet 12 with the adhesive 14 from the release liner 16. This is known as delamination. The web of label face stock 12 passes to insertion station 120 where an RFID transponder 18 is inserted onto the adhesive side 14 of the face sheet 12. Mechanism for delaminating the label stock from the release liner at station 150 comprises of a pair of free spinning idler rollers. The face stock with adhesive is simply peeled away from the release liner in opposite directions as the web moves over the rollers.

After insertion station 120, a relamination mechanism 160 for bringing label face stock 12 with RFID transponder 18 into contact with release liner 16 is provided. Preferably, a pair of nip rollers 162 is provided on press 100 for this purpose.

Relaminated label face stock 12 with the RFID transponder 18 and liner 16 is transported through a die cutting station 130, which may be used to perforate the web 10, form single labels, or both. Die cutting station 130 is held in registration with insertion station 120 so that label stock 10 may be cut without cutting through or damaging RFID transponder 18.

The process optionally provides one or more printing stations 140 prior to insertion station 120 for printing on the label stock 12 and optionally an adhesive applicator 160 for applying an adhesive-patch to RFID 18 insert while keeping the components in registration.

A similar insertion process is used for smart tags 70 without the delamination and relamination steps. The tag stock may bypass through the delamination and relamination mechanisms or the mechanisms may be disabled when tag stock is being used.

In addition, the process preferably provides one or more programming and/or verifying stations V1, V2 for verifying the functionality of each RFID transponder 18 either online during the insertion process or off-line.

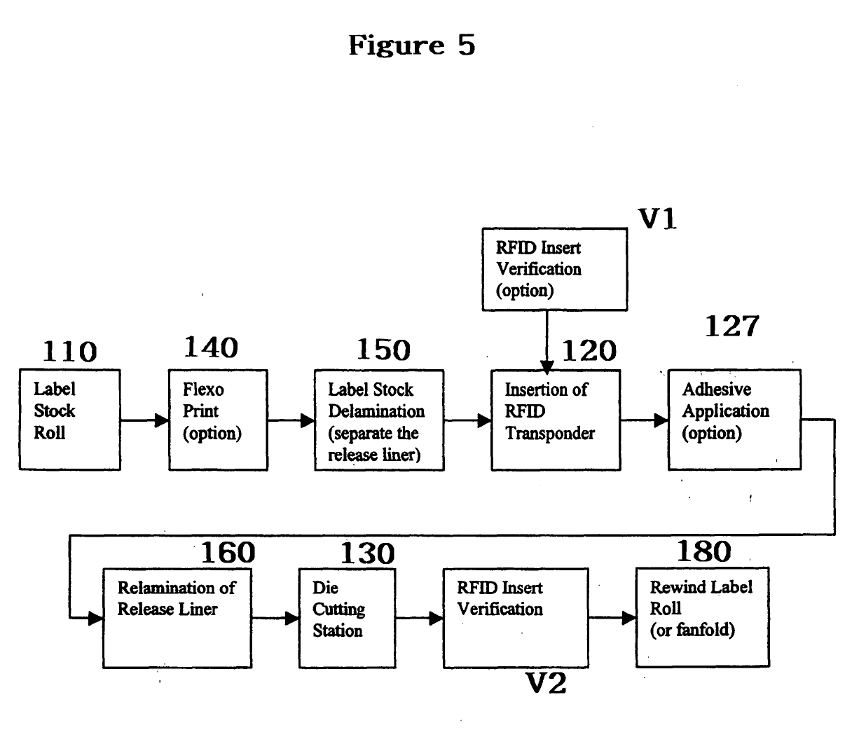

As shown in FIG. 5, a roll of label stock 10 obtained. Label stock 10 is threaded through the label press. The label stock can be threaded manually, automatically, or a combination of manual and automatic threading can be used. For example, the label stock may be threaded through a first set of rollers and then the web transported through the rest of the label path automatically. Optionally, label stock 10 is printed at one or more printing stations 140 before the web is transported to a delamination station.

Label stock 10 is delaminated by separating mechanism 150. In other words, label face sheet 12 is separated from the label release liner 16. RFID transponder 18 is inserted between the label face stock and the release liner.

RFID transponder 18 is preferably verified and optionally written to before insertion. If RFID transponder 18 is not able to be verified, the RFID transponder 18 can be bypassed and the next RFID transponder 18 used or the unverified RFID transponder 18 may be inserted but the label marked as unverified or defective. Optionally, the RFID transponder 18 may be verified immediately after insertion and if not able to be verified label marked as unverified.

Adhesive patch optionally may be applied to the RFID transponder to improve relamination of the liner. Release liner 16 is relaminated to label face stock 12. The label face stock 12, RFID transponder 18, and liner 16 sandwich proceeds to die cutting station 130.

RFID transponders 18 are optionally verified after the label web has passed through the die cutting station. Labels with RFID transponders 18 proceed to a rewind station 180 where they are either rolled or fanfold.

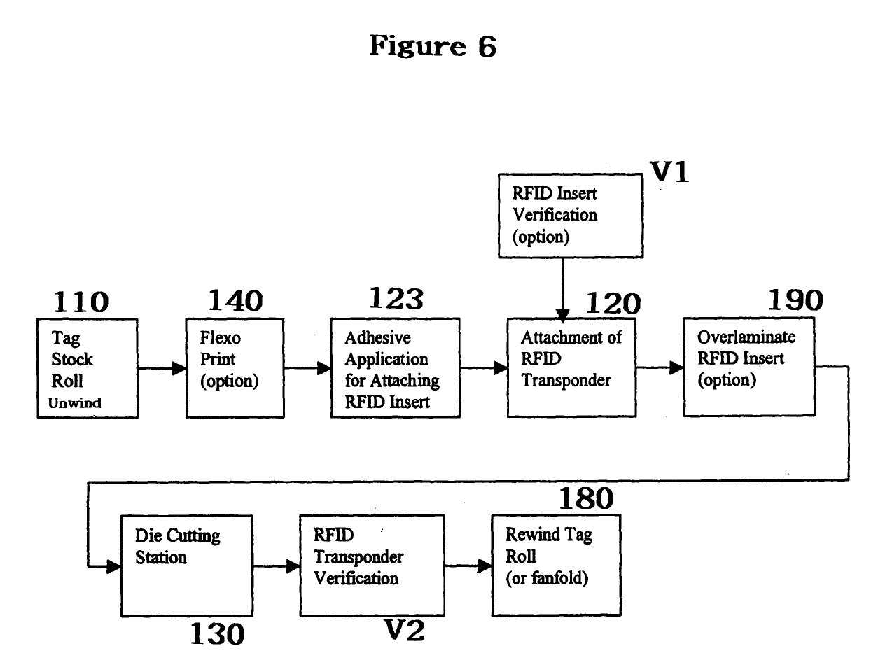

As shown in FIG. 6, when processing smart tags 70, a roll of tag stock 72 is obtained. Tag stock 72 is threaded through the insertion press. The tag stock 72 may bypass the delamination and/or relamination stations. Optionally, tag stock 72 may pass through the delamination and/or relamination stations with the delamination and relamination functions disabled.

Optionally, tags 72 on the web of tag stock are printed at printing station 140. Adhesive patch 74 is applied to tag stock 72. RFID transponder 18 is optionally programmed and/or verified prior to insertion. RFID transponder 18 is attached to tag stock 72 at the location of the adhesive patch 74. Optionally, RFID transponder 18 is programmed and/or verified after insertion.

An overlaminate may optionally be applied over RFID transponder 18 to protect the RFID transponder 18. The layered structure of tag stock 72 with attached RFID transponder 18 and optionally overlaminate 76 is sent to die cutting station 130, where tags 70 are die cut. RFID transponders 18 may be programmed and/or verified at this time. Tags 70 proceed to a rewind station 180 and are rerolled or fanfolded.

If RFID transponders 18 of labels 10 or tags 70 were not verified during the manufacturing process, they can be verified during later offline processing.

Labels 10 or tags 70 proceed to a slitting machine (not shown). Slitting machine may be an online slitting machine or an offline slitting machine. The labels 10 or tags 70 are verified for yield. Replacement RFID transponders 18 may be added to replace failed RFID transponders 18 by unwinding and rewinding the roll or within the fanfold and removing the defective RFID transponder 18 and replacing it with a verifiable RFID transponder 18.

During the inventive manufacturing process, the web or label stock 10 or tag stock 70 passes through press 100 having a series of online stations 110, 120, 130, 140, 150, 160, 170, 180, 190. The RFID tag or label is manufactured using a plurality of sequentially occurring steps, each occurring at an appropriate station in press 100. One or more tensioning devices are provided to control the tension of the web 10, 70 throughout the press 100. Registration at the die cut station 130 is controlled by web tension throughout the press. Web tension is maintained through a series of tensioning rollers. An optional means of monitoring inlay registration within the die cut label is done with a Hurletron unit.

A supply roll of label stock 10 or tag stock 70 is obtained. Label stock laminate 10 comprises a face sheet 12 having an adhesive 14 on one side laminated to release liner 16. Tag stock comprises a tag stock face sheet 72. Label face sheet 12 or tag face sheet 72 may be preprinted or unprinted.

Insertion press 100 has label or tag stock unwind station 110. Unwind station 110 supports at least one supply roll of label stock 10 or tag stock 70 on a hub. The supply roll of labels 10 or tags 70 is unwound and threaded through the press 100. Stock 10, 70 is threaded through press 100. Registration is not necessary for label web feeding into press prior to print stations. Label web alignment is accomplished with a web guide. Optionally, unwind station 110 may include a butt slicer which slices the web into the desired web width. It is preferable that the entire path of the press be adjusted prior to threading the label through press 100 so that the path is set to a single desired path width and that the path width be the same as the web width. The path width adjusted to the width of label or tag stock being used.

After unwind station 110, label stock 10 or tag stock 70 is preferably transported to one or more print stations 140. Print station 140 is capable of printing. Print station may utilize flexographic printing, off-set printing or another printing method. Inline printing of labels or tags is preferred as preprinting labels or tags requires an additional printing step and also requires additional registration and alignment steps.

After the last print deck, or after unwinding if there is no print station 140, and before insertion of RFID transponder 18, label stock 10 is transported to delamination station 150. A separating mechanism 152 or delamination element is provided to separate label face stock 12 from release liner 16 Mechanism for delaminating the label stock from the release liner at station 150 comprises of a pair of free spinning idler rollers. The face stock with adhesive is simply peeled away from the release liner in opposite directions as the web moves over the rollers. Label face stock 12 and adhesive 14 are transported to an insert station and label liner 16 is transported to relamination station.

Tag stock preferably bypasses delaminating station 150. Alternatively, tag stock passes through the delamination station 150, but separating mechanism 152 is deactivated or disabled and tag stock 70 passes through delamination station 150 unaffected.

Press 100 has an RFID transponder 18 supply station 120. A reel of RFID transponders is mounted on unwind spindle of an insert feeder unit 122. Reel is preferably, supported on both sides to prevent telescoping of reel. Unwind spindle preferably, allows reel to turn in either direction as the RFID transponders 18 may be wound in, i.e. the RFID chip 18 is facing the core of the reel and the web is facing the outside or out, i.e., the RFID chip 18 is facing out and the web is closer to the core. The RFID transponders 18 may be placed on web of label or tag stock 10, 70 either chip side up or chip side down without damage. Repeat lengths of individual inserts is preferably consistent within the reel. In an alternative embodiment, transponders 18 are placed further or closer together based on their position on the reel, in other words based on how far or closer the transponders 18 are from the core.

RFID transponders 18 on reel can be single wide or there may be multiple rows of RFID transponders 18 across width of web. Insertion station 120 preferably is adapted to handle multiple row webs. Individual streams of inserts are slit and redirected to the proper position across label web 10 or tag web 70. If the web of inserts 18 has multiple streams, insert web is unwound and slit it into more than one stream having the desired width using a butt slicer or other slicer.

The stream of RFID transponders on transponder web is fed to insertion station at a right angle to the label stock web machine direction. Right angle feed provides a means of turning the streams of inserts 18 over and offsetting the streams apart from one another. The press 10 includes an

RFID transponder take-up station comprises a take-up spindle. Take-up spindle rewinds unconsumed RFID transponders 18 that have been split, but not inserted due to the number of rows across the web.

A tensioning element to control the insert web tension is provided. This prevents stretching and damage to transponders 18. It also assists in maintaining proper registration of the web of transponders 18 with the insertion elements. A stability element is also provided. Stability element stabilizes reel and reduces bouncing and/or mistracking. The inlay web unwind and feed unit consists of an adjustable braking mechanism, a series of tensioning rollers, web guide(s), and a web stabilizer track to hold the web in place as it feeds past the registration sensor.

Alternatively, RFID transponders 18 can be in a batch hopper or stack infeed unit to accommodate individual RFID transponders 18 not provided in a continuous reel.

Press 100 preferably includes an RFID reel splicing table. RFID reel splicing table includes an element to either manually or automatically splice a new reel of RFID transponders 18 into an existing web of RFID transponders 18. Table includes a disengagement element to temporarily hold the two RFID webs during the splicing process. Preferably, the splicing table allows a portion of the RFID web to disengage momentarily from press while the new reel is spliced to it in without any disruption the insertion process.

The web of label stock 10 or tag stock 70 is transported to insertion station 120. Insertion station 120 comprises a channeled feed roller 124, at least one RFID transponder sensor, an insert separation element, a vacuum cylinder 126, a soft impression roller 128, and optionally, an adhesive applicator and RFID verifier V1.

Channeled feed roller 124 is preferably a servo roller the transports transponder 18 web. Channeled feed roller 124 has a channel to prevent direct contact between the RFID chips 18 facing the roller 124 and the roller surface. RFID transponder 18 is aligned with channel. This prevents RFID transponder 18 from being crushed, cracked or damaged.

Insertion station includes at least one RFID transponder sensor to sense the location of an individual RFID transponder 18 within the continuous reel of RFID transponders. In one embodiment, fiducial marks on the web of transponders 18 are sensed and used to determine the position of the RFID transponder. Alternatively, the sensor may trigger or read off of the antenna or chip package of the RFID transponder 18. In another embodiment, sprocket holes or a series of sprocket holes are used to determine the location of the RFID transponder. The sensors may use transmissive or reflective methods or visions systems. The position of the transponder is used to calculate any changes in registration needed to ensure that the RFID transponder is applied at the desired location on the label or tag stock. If a change in the feed location or present position is identified the system can make adjustments, such as adjustments in the tensioning elements and/or the speed of the webs. The tensioning elements compensate for small changes in the feed and application systems.

Online RFID verification and/or programming may be provided prior to RFID transponder 18 being inserted onto the label face stock 12 or the tag stock 72. A bad or defective RFID transponder 18 can be eliminated prior to insertion or the particular label identified as unverifiable or defective. RFID transponders can be verified for failures prior to insertion. Alternatively or additionally, the RFID transponder 18 can be verified and/or programmed after insertion into the label 10 or tag 70.

Online RFID verification V1 comprises an interrogator system comprising an RFID antenna or multiple antenna arrays for checking and testing the functionality of each RFID transponder 18. The verification system may use a reader capable of supporting multiple frequencies. The verification system may be an RFID reader or an RFID reader/writer. The verification system can log unique identifier (UID) numbers from RFID chips 18 and maintain a database record of good/bad RFID transponders processed. The verification system can calculate the yield of good inserts within a given supply reel. A database is provided for yield calculations of the supply reel. RFID transponders may be preprogrammed with a sequence number, which allows groups of inserts to be captured at the same time to speed up processing, any missing sequence numbers would be considered failures. Programming of the RFID transponders can also be done prior to inserting them into the label. A marking device to visibly mark failed RFID transponders 18 or a mechanism to automatically discarding failed RFID transponders 18 prior to inserting them into the label stock or tag stock is preferably provided.

Prior to being inserted into the tag or label web, the RFID transponders 18 are separated from the web carrying the RFID transponder. The insertion station 120 comprises a feed unit 122 that meters out the RFID transponders 18 at a preprogrammed rate to a vacuum cylinder. Inserts 18 are singulated at vacuum cylinder 126 by a cut-off cylinder. Blade 125a of cutoff cylinder 125 cuts against vacuum cylinder 126. Vacuum cylinder 126 has a plurality of apertures. Because there is a vacuum inside the cylinder, RFID transponder 18 is held by suction to the outer diameter of vacuum cylinder 126. Preferably, apertures are recessed in increase their holding power. The recessed design of apertures opens the holes up further to expand the suction area. To further focus and increase the holding power, the apertures are concentrated in an application portion of vacuum cylinder 126 such as the middle portion of vacuum cylinder 126. Vacuum cylinder 126 can be manufactured with apertures only in the application portion. Alternatively, apertures can be masked in areas other than application portion. For example, outer rows of vacuum apertures can be covered with tape. A release coating is preferably applied to mask or area without apertures to prevent sticking of the cylinder to the adhesive side of label stock web 10 or to an adhesive patch 72 on tag stock 70.

Singulated RFID transponders 18 are applied to label 10 or tag 70 stock at a speed that matches the speed of label 10 or tag stock web 70.

RFID transponders 18 are joined to label 10 or tag 70 stock with light pressure against the adhesive side of label stock 10 or adhesive patch on tag stock 72 without damaging the chip 18 or rollers. Insertion station 120 comprises a soft impression roller 128, such as a 20-durometer roller, for this purpose. Soft impression roller 128 prevents damage to RFID chips 18. Soft impression roller 128 is preferably positioned beneath label 10 web below vacuum cylinder 126. The RFID transponder and label face stock are sandwiched between the soft impression roller and the vacuum cylinder, the RFID transponder is adheres to adhesive and thus is removed from the vacuum cylinder and joined to the label or tag.

The insertion station rollers are preferably large diameter idler rollers. The large diameter of the rollers prevents damage to the RFID chips 18 by minimizing flexing and bending. The rollers are preferably made of a non-stick material or have a non-stick surface or coating to prevent the label stock adhesive 14 or the adhesive patch on the tag stock from grabbing the rollers during the time the liner 16 is delaminated or separated from the label face stock 12.

Insertion station 120 further comprises overhead tower web path 129. The path length of the overhead insertion equipment is preferably the least amount required to insert the RFID transponders 18 without damage. The span of the overhead tower web path 129 is minimized to maintain web tension and registration. Transponder web path 129 is laid out in a large circular pattern with as few “S” wraps as possible to minimize the potential for damage to the ASIC and antenna of the RFID transponder 18.

The insertion equipment provides a mechanism for producing an inserted product with the first label. Press 10, print stations 140 and die cutting stations 130 are set up and adjustments are made independent of insertion station 120. Insertion station 120 in not powered up or brought on line until the other stations 130, 140 are adjusted. Alternatively, insertion station 120 is online but dummy inserts are used until the proper alignment is achieved. Thus, when the first transponder 18 is inserted in label 10 or tag 70, transponder 18 is placed at the correct position and label 10 or tag 70 is good. This minimizes waste of transponders 18 which are very costly compared to label 10 or tag 70 stock. Transponders 18 are the highest cost material used in the process.

Insertion station 120 may be disabled or enabled during the setup and alignment procedure. Preferably, press 100 also includes a mechanism to bypass the insertion station or run press 100 with insertion station 120 disabled to produce ordinary die cut, printed labels or tags.

Insertion station 120 optionally comprises an adhesive applicator 127 for applying an adhesive to the continuous web of RFID transponders 18. Adhesive is preferably a pressure-sensitive hot melt adhesive When RFID transponder 18 is applied to adhesive 14 or sticky side of label stock 10, the exposed surface of RFID transponder 18 is coated with a patch of pressure sensitive adhesive 20. Alternatively, insertion station 120 optionally comprises an adhesive applicator 127 for applying adhesive to the continuous web of release liner 16. When RFID transponders 18 on label stock 10 are brought into contact with liner 16 during the label relamination procedure, adhesive patch 20 on liner 16 is transferred to the bare side of RFID transponder 18. A registration element is utilized to ensure adhesive patch 20 is registered with RFID transponder 18. The use of adhesive patch 20 is preferable when RFID transponder 18 will cover a substantial portion of label 10 because a bare insert. 18 would reduce label adhesion.

Insertion station 120 preferably includes an adhesive applicator 123 for applying a patch 74 of pressure-sensitive hot-melt adhesive to a continuous web of tag stock 70. When RFID transponders 18 on vacuum cylinder 126 are brought into contact with tag 70, adhesive patch 74 on tag 70 grabs and holds RFID transponder 18 in place. Adhesive patch 80 is positioned such that it is located where RFID transponder 18 is presented by vacuum cylinder 126.

Press 100 comprises a relamination station 160 positioned such that web of labels 10 and optionally tags 70 pass through the relamination station 160 after passing through insertion station 120 but prior to being transported to die cutting station 130. Relamination station 160 is adapted to bring label face stock 12 with adhesive 14 and RFID transponder 18 together with release liner 16. To prevent damage to RFID transponders 18, preferably a pair of soft nip rollers 162, such as 20-durometer rollers, are used for relamination. An alignment mechanism is provided to ensure proper alignment of labels 10 including any printed information with release liner 16 backing within specific tolerances. The tolerances may be predetermined or may be selected for the specific type of label 10 based on the side of label 10, the print, and other factors.

Optionally, press 100 comprises an over-laminating station 190. Over-laminating station 190 comprises a single over-laminate tape unwind station. Over-laminating station 190 preferably comprises a stabilization element to stabilizes the tape roll on tape unwind spindle. Over-laminating station 190 further comprises a pair of soft nip rollers after the tape supply. Tags 70, optionally, pass through over-laminating station 190 after insertion station 120 but prior to transport to die-cutting station 130. Tape 76 is applied over RFID transponder 18 to protect it. Tags 70 can be transported to overlaminate station instead of or in addition to disabled relamination station. The relamination station may optionally be used to introduce the tape supply to the tag stock. This would replace the release liner feeding into the relamination station 160.

Press 100 comprises at least one die cutting station 130. After labels 10 have been relaminated, labels 10 pass to die cutting station 130. Tags 70 may pass directly to die cutting station 130 from insertion station 120. Die cutting station 130 comprises a cutting element. Cutting element may be one or more rotary die or other types of tooling or cutting, perforating or sheeting element used for forming labels or tags. At die cutting station 130 labels 10 or tags 70 are cut, perforated and/or sheeted. Die cutting station 130 preferably comprises a monitor or sensor to identify the location of RFID transponder 18 within label 10 or tag 70. For example, RFID transponder 18 location may be monitored by a Hurletron unit. The sensor is used to determine the location of the RFID transponder 18. The position of the web may be adjusted to prevent RFID transponder 18 from passing directly under the die blades.

If the RFID transponder were to pass directly under the die blades, the transponder 18 would be damaged and the label or tag unusable. Further, because the ASIC is enclosed in a hard epoxy like an MSOP package, it may damage the die if it were to pass directly under the cutting surface. Preferably, RFID monitor comprises computer-controlled sensors on each side of insertion station 120. The sensors detect the position of RFID transponder 18 and compares the observed position with an expected position based on programmed variables such as label 10 or tag 70 size, RFID size, and/or web speed. If the RFID transponder 18 is located at the expected position the label or tag web passes through the die cutting station 130. If the deviation is small or within a predetermined tolerance, the system will allow the label or tag web to pass through the die cutting station 130. Preferably, the system will flash a warning that the RFID insert is out of position such as by flashing a yellow light and/or sounding an alarm. Optionally, the system can continue to process labels 10 or tags 70 until a deviation of a predetermined magnitude is reached. Optionally, if the deviation is constant or increasing, the location of the web may be adjusted or the insert position of the RFID transponders 18.

If the deviation is large enough that transponder 18 will pass beneath one of the die blades, the system will preferably flash a red light, sound an alarm and engage an emergency stop. Alternatively, the position of the web may be adjusted to correct for the placement of the RFID transponder 18.

Mechanism for verifying RFID transponders 18 can be provided on-line after the last die cutting station 130 and prior to the label web passing to label rewind station 180. Online RFID verification V2 comprises an interrogator system comprising an RFID antenna or multiple antenna arrays for checking and testing the functionality of each RFID transponder 18. The verification system may use a reader capable of supporting multiple frequencies. The verification system may be an RFID reader or an RFID reader/writer. The verification system can log UID numbers from RFID chips 18 and maintain a database record of good/bad inserts processed. The verification system can calculate the yield of good inserts within a given supply reel or within a given insertion run. A database is provided for yield calculations. If the press includes a first online verifier V1, second verifier V2 database may be linked to first verifier V1 database for yield calculations.

RFID transponders 18 may be preprogrammed with a sequence number, which allows groups of inserts 18 to be captured at the same time to speed up processing, any missing sequence numbers would be considered failures. Programming of the RFID transponders 18 can also be done at this time. A marking element to visibly mark unverifiable or failed RFID transponders 18 may be provided. The marking element may be an ink jet printer or other printer that marks the labels as they pass. Verifier V2 can be used to read UID numbers from RFID-transponder ASIC and write this number on label or tag with the marking element for tracking in the event of electronic failure of the RFID transponder 18.

After the web 10, 70 passes last rotary die cutting station 130 and prior to web 10, 70 entering rewind station 130, there is preferably a web break detector. The web break detector will stop press 100 when web break detector recognizes a loss of web tension. Press 100 further comprises a label rewind station 180. Labels 10 or tags 70 pass from the die cutting station and optionally from verifier V2 to rewind station 180. Rewind station 180 comprises at least two rewind spindles. Rewind station 180 comprises rewind spindle that preferably accepts 3-inch and 4-inch cores. Rewind spindle may accept other size cores. Core is stabilized and held in position on the rewind spindle with edge guide tabs or other stability elements. Rewind station 180 has a wind tension control system that preferably utilizes a differential tension controller to prevent crushing of RFID transponders 18. Wind tension controller produces a tapered tension whereby the tension exerted on the roll at the beginning of rewind, i.e., near the core is higher that the tension exerted at the end of the roll. Alternatively, tags 70 or labels 10 can be send to a fan-folding station.

Press 100 further comprises a static control system. Static control system is provided throughout the entire manufacturing process to reduce the chance of electrostatic discharge (ESD) damage. Static control system is capable of neutralizing any level of static generated within the entire manufacturing process.

The press 100 further comprises a segmented exit nip roller. The exit nip roller is segmented to prevent crushing and damage to RFID chips from direct contact.

The system also may include one or more offline finishing stations.

An off-line slitter 200 and/or rewinder 210 may be provided for producing finished rolls. These are typically used to produce rolls that are smaller in diameter than what comes off press 100.

An off-line RFID verification V3 station may optionally be provided. Verification station V3 comprises an interrogator system comprising an RFID antenna or multiple antenna arrays for checking and testing the functionality of each RFID transponder 18 of a roll of RFID smart labels or tags. The verification system may use a reader capable of supporting multiple frequencies. The verification system may be an RFID reader or an RFID reader/writer. The verification system can log unique identifier (UID) numbers from RFID chips 18 and maintain a database record of good/bad RFID transponders 18 processed. RFID transponders may be preprogrammed with a sequence number, which allows groups of inserts to be captured at the same time to speed up processing, any missing sequence numbers would be considered failures. Verification system V3 can be used to control label web movement and to stop/start the web for manual removal and replacement of failed RFID transponders 18 at replacement station 220.

Programming of RFID transponders 18 can also be done at verification station V3. A marking element to visibly mark failed RFID transponders 18 is provided. The marking element may be a ink jet printer or other printer that marks the labels as they pass through the printer. Verifier V3 can be used to read UID numbers from RFID transponder ASIC and write this number on label 10 or tag 70 with the marking element for tracking in the event of electronic failure of RFID transponder 18.

We claim:

1. A method for manufacturing RFID labels comprising the steps of:
obtaining a roll of media on an unwind station of an insertion press, said press comprising the unwind station, an insertion station, a die cutting station, and a rewind station;
threading the media through at least some of the stations of the press;
transporting the media to the insertion station;
joining an RFID transponder to a second side of the media at the inseration station;
transporting the media and RFID transponder to the die cutting station;
die cutting the media at the die cutting station;
transporting the die cut media to a rewind station;
rewinding or fan folding the media at the rewind station.

2. The method of claim 1 further comprising the steps of:
transporting the media to a print station before the insertion station; and
printing the media at the print station.

3. The method of claim 1 further comprising the step of verifying the RFID transponder at least once prior to rewinding or fan folding the media.

4. The method of claim 1 wherein the media a label stock comprising a label face sheet having adhesive on the second side and a release liner further comprising the steps of:
transporting the label stock to a delamination station prior to transporting the media to the insertion station;
separating the label face stock and adhesive from the release liner at the delamination station;
transporting the label face sheet and RFID transponder to a relamination station prior to the die cutting station; and
relaminating the release liner to the label face sheet.

5. The method of claim 4 further comprising the steps of:
transporting the media to a print station before the insertion station; and
printing the media at the print station.

6. The method of claim 4 further comprising the step of verifying the RFID transponder at least once prior to rewinding or fan folding the media.

7. The method of claim 4 further comprising the step of:
applying an adhesive patch to the RFID transponder or the release liner prior to relaminating the release liner and the label face sheet.

8. The method of claim 1 wherein the media comprises tag stock further comprising the step of applying an adhesive patch to the RFID tag or the second side of the tag stock before joining the RFID transponder to the media.

9. The method of claim 8 further comprising the steps of:
transporting the media to a print station before the insertion station; and
printing the media at the print station.

10. The method of claim 8 further comprising the step of verifying the RFID transponder at least once prior to rewinding or fan folding the media.

11. The method of claim 8 further comprising the steps of:
unwinding an overlaminate media; and
applying the overlaminate media to the tag and RFID transponder prior to transporting the media to the die cutting station.

12. The method of claim 1 wherein the RFID transponders are carried on a first reel of RFID transponders further comprising the step of:
splicing a second reel of RFID transponders to the first reel of RFID transponders without bringing the press offline.

13. The method of claim 1 further comprising the steps of:
maintaining the media web in registration with the RFID transponder web.

14. The method of claim 4 further comprising the steps of maintaining the label face sheet in registration with the RFID transponder web and the release liner.

15. The method of claim 1 further comprising the step of:
sensing the location of the RFID transponder before die cutting the media.

16. A insertion press for automatically joining RFID transponders to a media web comprising:
an unwind station;
a delamination station;
an insertion station,
a relamination station;
a die cutting station,
a rewind station; and
at least one verifier.

17. The insertion press of claim 16 further comprising at least one print station.

18. The insertion press of claim 16 wherein the insertion station comprises:
an RFID transponder feed unit to supply single RFID transponders at a determined rate to a vacuum cylinder;
the vacuum cylinder having a plurality of apertures in a suction area and a non-stick area; and
a soft impression roller positioned beneath the vacuum cylinder to sandwich a media web between the vacuum cylinder and the soft impression roller.

19. The insertion press of claim 16 wherein the RFID transponder supply comprises a spindle supported at least one end, said spindle supports a reel of RFID transponders,
a channel roller feed to transport a transponder web; and
a RFID sensor.

20. The insertion press of claim 18 wherein the insertion station further comprises an adhesive applicator.
